(19) United States
(12) Patent Application Publication
(10) Pub. No.: US 2021/0322971 A1
(43) Pub. Date: Oct. 21, 2021

(54) SQUARE CONTACT PLATE

(71) Applicants: S2M Enterprises, LLC, Spokane Valley, WA (US); QI Medical, Grass Valley, CA (US)

(72) Inventors: Stephanie Bernards, Spokane, WA (US); Sommer Teague, Spokane, WA (US); Molly Paridon, Spokane, WA (US); Brady Schwarz, Grass Valley, CA (US)

(73) Assignee: QI Medical

(21) Appl. No.: 17/235,199

(22) Filed: Apr. 20, 2021

Related U.S. Application Data
(60) Provisional application No. 63/013,076, filed on Apr. 21, 2020.

(51) Int. Cl. B01L 3/00

(52) U.S. Cl. CPC B01L 3/508; B01L 2200/087; B01L 2200/18; B01L 2300/041; B01L 2300/0809

(57) ABSTRACT

Described herein is a contact plate for microbial testing and sampling of corner surfaces. The contact plate may comprise a base having a first side and a second side. The first side may have a first wall and a second wall extending outward from the first side of the base to form a corner and define a surface for collecting biological samples. Additionally, the contact plate may include a rectangular lid configured to secure around the first wall and the second wall, and/or a handle removably coupled to the second side of the base.

### RELATED APPLICATIONS

This application claims priority to U.S. Provisional Patent Application No. 63/013,076, filed Apr. 21, 2020, titled “Square Contact Plate,” the entire contents of which are incorporated herein by reference.

### BACKGROUND

Designs for contact plates that allow for assaying biological material may be desired. Described herein are improvements in technology and solutions to technical problems that can be used to, among other things, manufacture and utilize contact plates.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a three-dimensional top view of an example of a contact plate base and lid.

FIG. 2 illustrates a three-dimensional top view of an example of a contact plate base.

FIG. 3 illustrates a two-dimensional top view of an example of a contact plate base.

FIG. 4 illustrates a two-dimensional front side view of an example of a contact plate base.

FIG. 5 illustrates a two-dimensional bottom side view of an example of a contact plate base.

FIG. 6 illustrates a three-dimensional top view of an example of a contact plate base.

FIG. 7 illustrates a three-dimensional bottom view of an example of a contact plate base.

FIG. 8 illustrates a two-dimensional bottom side view of an example of a contact plate base with a handle insertion apparatus.

FIG. 9 illustrates a three-dimensional bottom side view of an example of a contact plate base with a handle insertion apparatus.

FIG. 10 illustrates a three-dimensional bottom side view of an example of a contact plate base with a handle insertion apparatus and an attached contact plate handle.

FIG. 11 illustrates a three-dimensional view of an example of a contact plate handle.

FIG. 12 illustrates a two-dimensional top view of an example of a contact plate base.

FIG. 13 illustrates a two-dimensional top view of an example of a contact plate lid.

FIG. 14 illustrates a two-dimensional bottom view of an example of a contact plate lid.

FIG. 15 illustrates a two-dimensional front side of an example of a contact plate lid.

FIG. 16 illustrates a three-dimensional top view of an example of a contact plate lid.

FIG. 17 illustrates a three-dimensional front view of an example of a contact plate base.

FIG. 18 illustrates a three-dimensional front view of an example first contact plate base stacked upon a second contact plate.

### DETAILED DESCRIPTION

Devices for a contact plate are described herein. Currently, environmental monitoring of surfaces and/or people for microbes (including bacteria, yeast, and mold) is conducted in several industries including those related to pharmaceuticals, food, cosmetics, household products, and laboratories, to name a few examples. Cleanrooms are a critical component of these scientific industries and are relied upon heavily in scientific research and industrial production. For example, cleanrooms are essential to manufacturing pharmaceutical items and microprocessors. While cleanrooms are designed to maintain ultra-low levels of microbes, particulates, and other organisms, monitoring the integrity of cleanrooms and potential contamination is critical. To monitor surfaces and personnel in cleanrooms, contact plates may be used for microbial testing and surface sampling. However, current technology does not allow users to sample square corners, edges, and/or surfaces.

The present innovation is directed to a contact plate that may be used to sample corners and/or edges of sampling surfaces, allowing a user to monitor surfaces, air, personnel, and/or other aspects of cleanrooms and/or isolators, for example. In examples, the contact plate may include a base, which may have at least a first side and/or a second side opposite the first side. The first side may have an upper portion, including a first wall and/or a second wall extending outward from a lower side of the first side of the base. The first wall and the second wall may, in examples, form a right angle, which may be straight or rounded with a radius of less than 360 degrees. The first wall and/or the second wall may, in examples, define a rectangular surface sized to receive one or more biological samples. In some examples, an area of the base may be greater than the rectangular surface, defining a surface of the contact plate that allows for handling the contact plate without a handler physically coming into contact with, therefore compromising, the area sized to receive the biological sample(s). In examples, this surface may be connected to a handle. Additionally or alternatively, the contact plate may include a rectangular lid configured to secure around the one or more walls and/or a handle removably coupled to the second side of the base.

In examples, the lid may contain an open side, wherein the open side may fit around the first wall and/or the second wall of the upper portion. Additionally or alternatively, the lid may contain a friction locking mechanism in which the rectangular surface sized to receive the biological sample(s)may be secured in place. In examples, the lid may contain a closed side that provides a barrier between the environment and the rectangular surface sized to receive the biological sample(s), thus sealing the substance from the environment. In examples, the bottom of the contact plate may be, but is not limited to, convex, flat, and/or curved in shape.

In some examples, the contact plate may have varying dimensions according to the contact plate's functionality and/or utilization. In examples, the contact plate base may have a length and/or width from about 30 millimeters (mm) to about 100 mm. However, the contact plate base may have other lengths and widths. The bottom portion of the contact plate base may have a height from about 3 mm to about 15 mm. However, the contact plate base may have other heights.

The area of the rectangular surface sized to receive one or more biological samples may have dimensions which may dictate the function and/or utility of the device. This area may be, in some cases, smaller than the area of the contact base plate and may have a length and/or width from about 30 mm to about 100 mm. In examples, the first wall and/or the second wall of the upper portion may have a height from about 3 mm to about 15 mm. Additionally or alternatively, the first wall and/or the second wall may have a thickness from about 1 mm to about 10 mm

The surface of the contact plate that allows for handling may have dimensions which dictate the function and/or utility of the device. The dimensions of the area of the contact plate that allows for handling may be similar to the area of the entire base of the contact plate and may have a length and/or width from about 30 mm to about 100 mm. The surface of the contact plate that allows for handling may have a height from about 3 mm to about 20 mm.

The area of the rectangular surface sized to receive the biological sample(s) may be marked by a grid to define clear sectors. The grid may consist of at least one parallel line and at least one perpendicular line. In examples, the grid may be marked by letters and/or numbers. The markings may exist on the edge(s) and/or the surface of the area of the rectangular surface sized to receive the biological sample(s), for example.

The second side of the contact plate may contain an apparatus which may enable the insertion of at least one removable handle. The apparatus may be centered and/or offset on the second side of the contact plate. In examples, the apparatus may enable the insertion of a removable handle through a twist-and-lock mechanism wherein the apparatus has two slots and grooves which allow a handle to be inserted into the slots and then twisted into the grooves to lock into place. In other examples, the apparatus may enable the insertion of a removable handle through a screw mechanism, where the apparatus and handle contain grooves in a similar screw pattern. In other examples, the apparatus may enable a tab mechanism in which the apparatus contains a groove to insert a tab on the handle, wherein the handle can be removed by depressing the tab.

Additional details are described below with reference to several example embodiments.

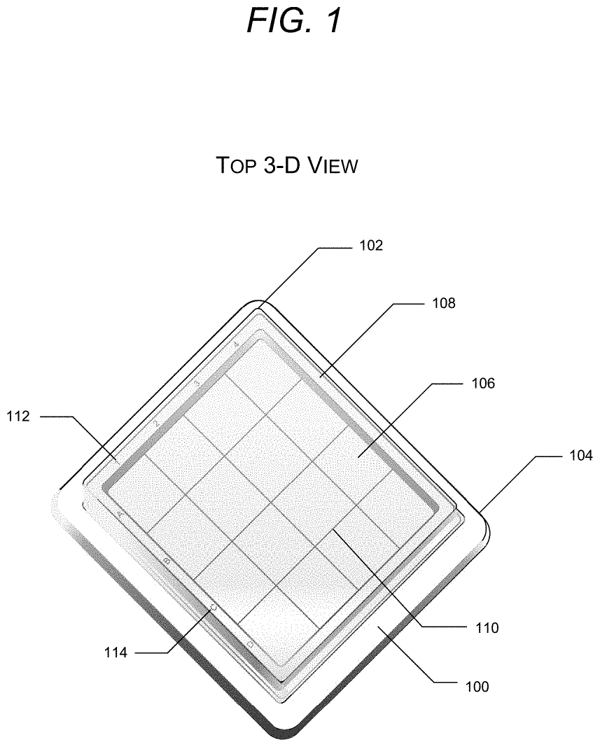

FIG. 1 illustrates a three-dimensional top view of an example of a contact plate base and lid. The contact plate base 100 and lid 102 may be generally of square or rectangular shape with rounded corners with radii ranging from about 0.5 mm to about 20 mm. However, other radii may also be used. The contact plate base 100 may have a lower portion 104 and upper portion 108. The lower portion 104 may have a thickness from about 2 mm to about 10 mm, for example. The upper portion 108 may have a thickness from about 1 mm to about 10 mm. However, other thicknesses may be used. The upper portion 108 may define an interior space 106 that may be sized to receive one or more biological samples. The lower portion 104 may have a width from about 1 mm to about 10 mm on the widest sides (the bottom-left and bottom-right sides in FIG. 1) and from about 0.5 mm to about 5 mm on the narrowest sides (the top-left and top-right sides in FIG. 1). The interior space 106 may have dimensions from about 30 mm to about 100 mm in length and/or width. In examples, the interior space 106 may contain a grid 110 that may provide clearly defined sections of the interior space. The grid may be marked by numbers 112 and/or letters 114 on the edge of the upper portion 108. The dimensions of each section in the grid may have dimensions from about 2 mm to about 12 mm. The lid 112 may consist of four sides that may extended perpendicular to a fifth side which may function as the top portion of the lid, and a sixth side that may be open to allow for the lid to fit over the edge of the upper portion. The dimensions of the lid 112 may be from about 30 mm to about 100 mm in length and/or width. The lid may be designed such that it may fit over the upper portion of the fifth side and rest on the edge of the upper portion and/or bottom of the four sides contacting the surface of the lower portion 104.

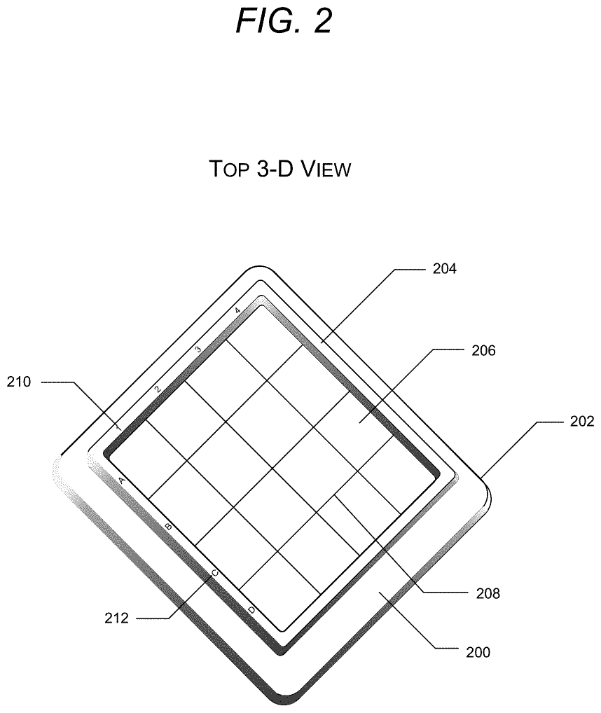

FIG. 2 illustrates a three-dimensional top view of an example of a contact plate base. In examples, the contact plate base 200 may be generally of square or rectangular shape with rounded corners with radii ranging from about 0.5 mm to about 20 mm. However, other radii may be used. In examples, the contact plate base 200 may have a lower portion 202 and an upper portion 204. The lower portion 202 may have a thickness from about 1 mm to about 10 mm. Similarly, the upper portion 204 may have a thickness from about 1 mm to about 10 mm. In examples, the upper portion 204 may be off-centered on the lower portion 200 such that the width of the portion measured from the edge of the lower portion 200 to the base of the upper portion 204 may be from about 1 mm to about 10 mm on the widest sides (the bottom-left and bottom-right sides in FIG. 2) and from about 0.5 mm to about 5 mm on the narrowest sides (the top-left and top-right sides in FIG. 2). In examples, the upper portion 204 may be off-centered on the lower portion 200 such that each portion measured from the edge of the lower portion 200 to the base of the upper portion 204 has a different width. Alternatively, the upper portion 204 may be centered on the lower portion 200. The upper portion 204 may define an interior space 206 that may be sized to receive one or more biological samples. In examples, the interior space 206 may have dimensions from about 30 mm to about 100 mm in length and width. In examples, the interior space 206 may also contain a grid 208 that may provide clearly defined sections of the interior space. The grid may be marked by numbers 210 and letters 212 on the edge of the upper portion 204. The dimensions of each section in the grid may have dimensions from between about 2 mm to about 12 mm.

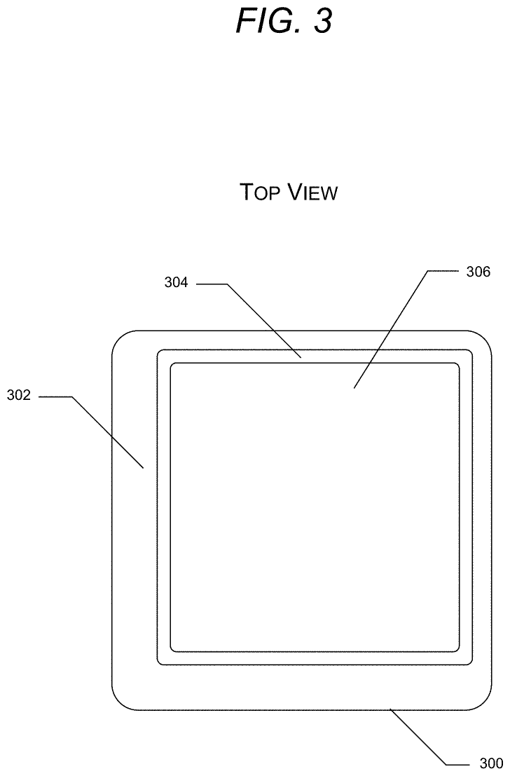

FIG. 3 illustrates a two-dimensional top view of an example of a contact plate base. In examples, the contact plate base 300 may be generally of square or rectangular shape with rounded corners with radii ranging from about 0.5 mm to about 20 mm. However, other radii may be used. In this example, the contact plate base 300 has a lower portion 302 and an upper portion 304 containing four walls. The lower portion 302 may have a thickness from about 1 mm to about 10 mm. Similarly, the upper portion 304 may have a thickness from about 1 mm to about 10 mm. In examples, the upper portion 304 may be off-centered on the lower portion 300 such that the width of the portion measured from the edge of the lower portion 300 to the base of the upper portion 304 may be from about 1 mm to about 10 mm on the widest sides (the bottom-left and bottom-right sides in FIG. 3) and from about 0.5 mm to about 5 mm on the narrowest sides (the top-left and top-right sides in FIG. 3). In examples, the upper portion 304 may be off-centered on the lower portion 300 such that each portion measured from the edge of the lower portion 300 to the base of the upper portion 304 has a different width. Alternatively, the upper portion 304 may be centered on the lower portion 300. The upper portion 304 may define an interior space 306 that may be sized to receive one or more biological samples. The interior space 306 may have dimensions from about 30 mm to about 100 mm in length and/or width.

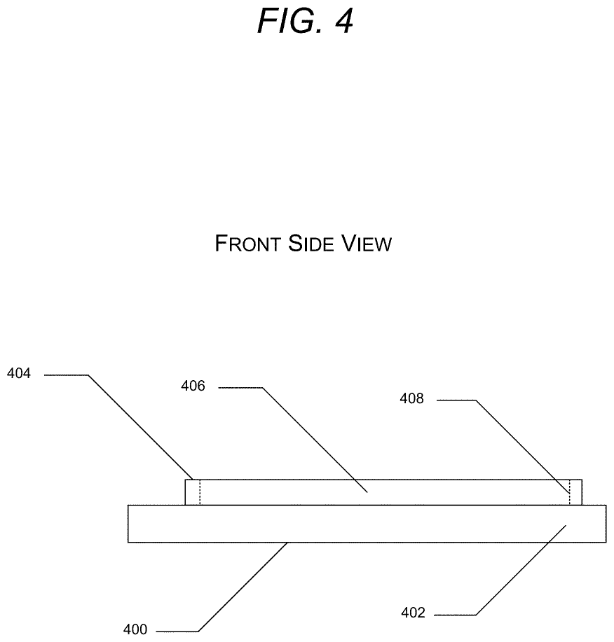

FIG. 4 illustrates a two-dimensional front side view of an example of a contact plate base. In examples, the contact plate base 400 may be generally of square or rectangular shape with rounded corners with radii ranging from about 0.5 mm to about 20 mm. However, other radii may be used. In examples, the contact plate base 400 may have a lower portion 402 with a defined thickness and an upper portion 404 with a similar or different defined thickness. The defined thickness of the lower portion 402 may be from about 1 mm to about 10 mm. The defined thickness of the upper portion 404 may be from about 1 mm to about 10 mm. The upper portion 404 may, in examples, be comprised of four walls and define an interior space 406 that may be sized to receive one or more biological samples. In examples, the interior space 406 may have dimensions from about 30 mm to about 100 mm in length and/or width. In examples, the interior space may be, at least in part, defined by the thickness of the upper portion and/or the interior edges of the upper portion 404. This may be indicated by the dashed lines marking the interior edges 408 of the upper portion 404.

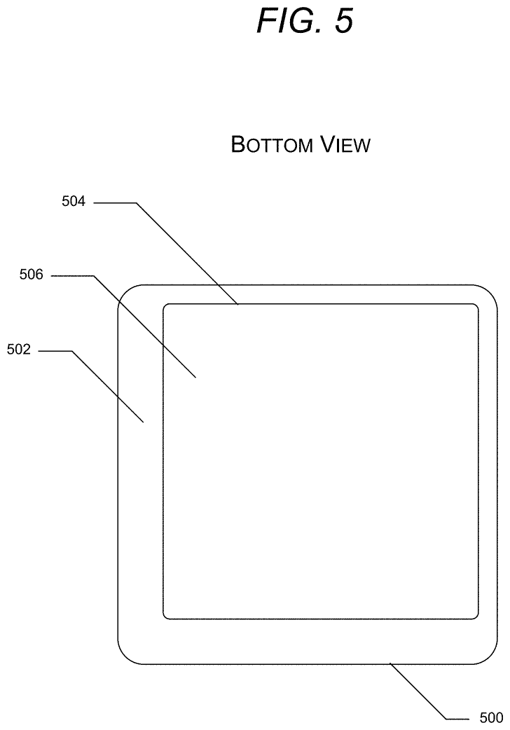

FIG. 5 illustrates a two-dimensional bottom view of an example of the second side of the contact plate base. In examples, the contact plate base 500 may be generally of square or rectangular shape with rounded corners with radii ranging from about 0.5 mm to about 20 mm. However, other radii may be used. In examples, the contact plate base 500 may have a lower portion 502 and an upper portion 504. In examples, the upper portion 504 may be off-centered on the lower portion 500 such that the width of the portion measured from the edge of the lower portion 500 to the base of the upper portion 504 may be from about 1 mm to about 10 mm on the widest sides (the bottom-left and bottom-right sides in FIG. 5) and from about 0.5 mm to about 5 mm on the narrowest sides (the top-left and top-right sides in FIG. 5). In examples, the upper portion 504 may be off-centered on the lower portion 500 such that each portion measured from the edge of the lower portion 500 to the base of the upper portion 504 has a different width. Alternatively, the upper portion 504 may be centered on the lower portion 500. The upper portion 504 in this view is the backside of the interior space 106, 206, and 306, and may define an interior space 506 sized to receive one or more biological samples and may have dimensions from about 30 mm to about 100 mm in length and/or width.

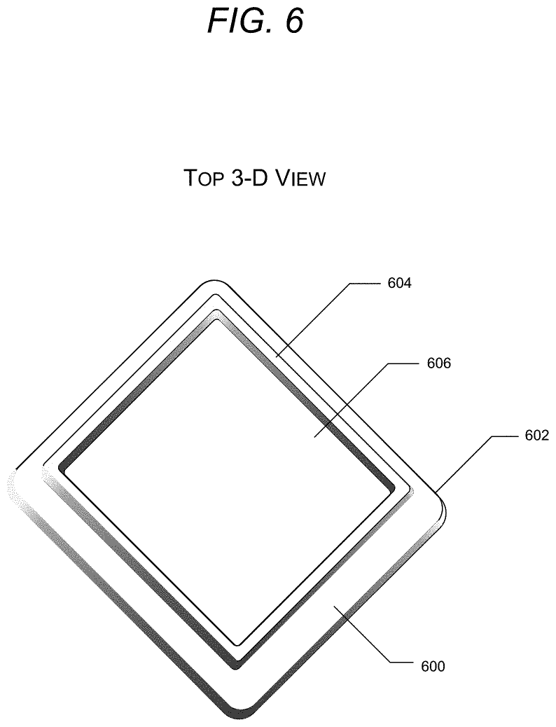

FIG. 6 illustrates a three-dimensional top view of an example of a contact plate base. In examples, the contact plate base 600 may be generally of square or rectangular shape with rounded corners with radii ranging from about 0.5 mm to about 20 mm. However, other radii may be used. The lower portion 602 may have a thickness from about 1 mm to about 10 mm. Similarly, the upper portion 604 may have a thickness from about 1 mm to about 10 mm. In examples, the upper portion 604 may be off-centered on the lower portion 600 such that the width of the portion measured from the edge of the lower portion 600 to the base of the upper portion 604 may be from about 1 mm to about 10 mm on the widest sides (the bottom-left and bottom-right sides in FIG. 6) and from about 0.5 mm to about 5 mm on the narrowest sides (the top-left and top-right sides in FIG. 6). In examples, the upper portion 604 may be off-centered on the lower portion 600 such that each portion measured from the edge of the lower portion 600 to the base of the upper portion 604 has a different width. Alternatively, the upper portion 604 may be centered on the lower portion 600. In examples, the upper portion 604 may define an interior space 606 that may be sized to receive one or more biological samples. In examples, the interior space 606 may have dimensions from about 30 mm to about 100 mm in length and/or width.

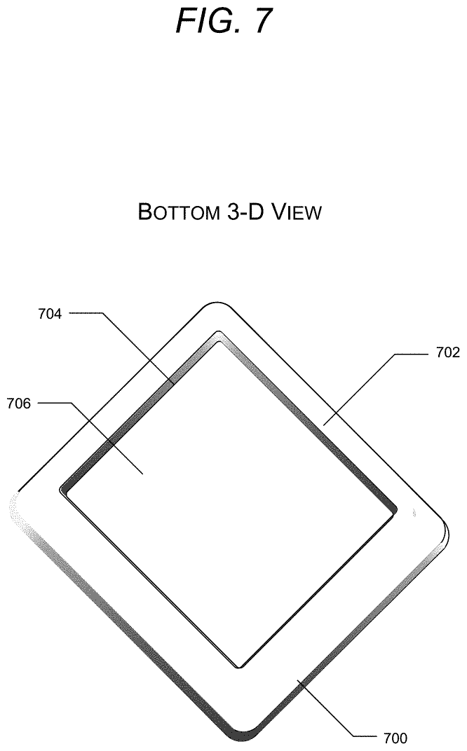

FIG. 7 illustrates a three-dimensional bottom view of an example of a second side of a contact plate base. In examples, the contact plate base 700 may be generally of square or rectangular shape with rounded corners with radii ranging from about 0.5 mm to about 20 mm. However, other radii may be used. In examples, the contact plate base 700 may have a lower portion 702 and an upper portion 704. In examples, the upper portion 704 may be off-centered on the lower portion 700 such that the width of the portion measured from the edge of the lower portion 700 to the base of the upper portion 704 may be from about 1 mm to about 10 mm on the widest sides (the bottom-left and bottom-right sides in FIG. 7) and from about 0.5 mm to about 5 mm on the narrowest sides (the top-left and top-right sides in FIG. 7). In examples, the upper portion 704 may be off-centered on the lower portion 700 such that each portion measured from the edge of the lower portion 700 to the base of the upper portion 704 has a different width. Alternatively, the upper portion 704 may be centered on the lower portion 700. The upper portion 704 in this view is the backside of the interior space 106, 206, and 306, and may define an interior space 706 which may have dimensions from about 30 mm to about 100 mm in length and/or width.

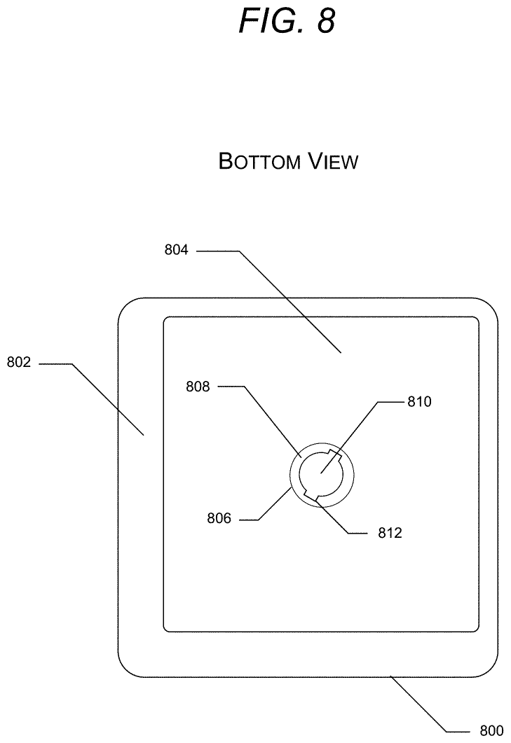

FIG. 8 illustrates a two-dimensional bottom view of an example of a contact plate base with a handle insertion apparatus. In examples, the contact plate base 800 may be generally of square or rectangular shape with rounded corners with radii ranging from 0.5 mm to about 20 mm. However, other radii may be used. In examples, the contact plate base 800 may have a lower portion 802 and an upper portion 804. In examples, the upper portion 804 may be off-centered on the lower portion 800 such that the width of the portion measured from the edge of the lower portion 800 to the base of the upper portion 804 may be from about 1 mm to about 10 mm on the widest sides (the bottom-left and bottom-right sides in FIG. 8) and from about 0.5 mm to about 5 mm on the narrowest sides (the top-left and top-right sides in FIG. 8). In examples, the upper portion 804 may be off-centered on the lower portion 800 such that each portion measured from the edge of the lower portion 800 to the base of the upper portion 804 has a different width. Alternatively, the upper portion 804 may be centered on the lower portion 800. The upper portion 804 in this view is the backside of the interior space 106, 206, and 306, and may define an interior space which may have dimensions from about 30 mm to about 100 mm in length and/or width. The upper portion 804 may also contain a handle insertion apparatus 806. The handle insertion apparatus 806 may allow for the insertion of a removable handle to allow for the contact plate to be held and maneuvered without directly touching the top surface of the contact plate. The handle insertion apparatus 806 may have certain dimensions to enable specific functionality. In examples, the handle insertion apparatus 806 may be circular in shape with the outer edge 808 having a diameter from about 4 mm to about 16 mm. The outer edge may have a thickness from about 0.5 mm to about 5 mm, and a height from about 1 mm to about 10 mm. The handle insertion apparatus 806 may have a receiving component 810 that may be hollow and may serve as the receiving end of at least a portion of the handle. In examples, the receiving component may be circular in shape and may have a diameter from about 3 mm to about 15 mm and a height from about 1 mm to about 8 mm. The handle insertion apparatus 806 may also contains receiving slots 812 which may be designed to receive specific structures of the receiving handle 806. The receiving slots 812 may be equidistant on the circumference of the receiving component 810 and may be hollow. The receiving slots 812 may have a width and/or height from about 0.5 mm to about 8 mm.

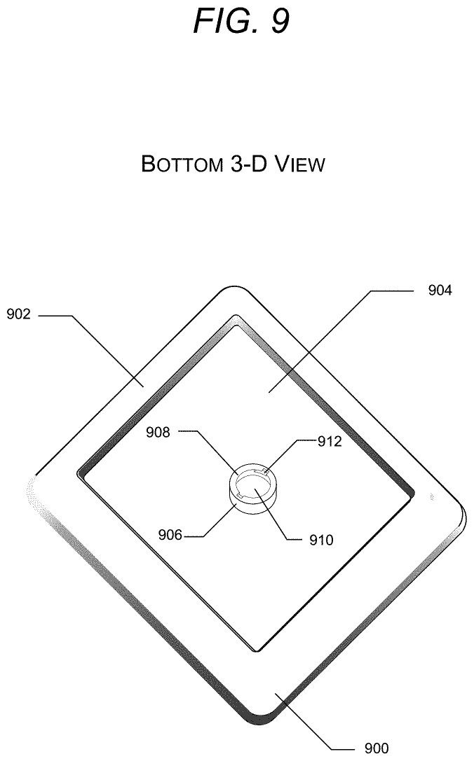

FIG. 9 illustrates a three-dimensional bottom side view of an example of a contact plate base with a handle insertion apparatus. In examples, the contact plate base 900 may be generally of square or rectangular shape with rounded corners with radii ranging from about 0.5 mm to about 20 mm. However, other radii may be used. In examples, the contact plate base 900 may have a lower portion 902 and an upper portion 904. In this example, the lower portion 902 appears closer to the viewer than the upper portion 904. In examples, the upper portion 904 may be off-centered on the lower portion 900 such that the width of the portion measured from the edge of the lower portion 900 to the base of the upper portion 904 may be from about 1 mm to about 10 mm on the widest sides (the bottom-left and bottom-right sides in FIG. 9) and from about 0.5 mm to about 5 mm on the narrowest sides (the top-left and top-right sides in FIG. 9). In examples, the upper portion 904 may be off-centered on the lower portion 900 such that each portion measured from the edge of the lower portion 900 to the base of the upper portion 904 has a different width. Alternatively, the upper portion 904 may be centered on the lower portion 900. The upper portion 904 in this view is the backside of the interior space 106, 206, and 306, and may define an interior space which may have dimensions from about 30 mm to about 100 mm in length and/or width.

The upper portion 904 may also contain a handle insertion apparatus 906. The handle insertion apparatus 906 may function as an insertion for a removable handle which may allow for the contact plate to be held and maneuvered without directly touching its top surface. In examples, the handle insertion apparatus 906 may attach and/or detach to the upper portion 904 through a screw-thread system. The handle insertion apparatus 906 may have certain dimensions to enable specific functionality. In examples, the handle insertion apparatus 906 may be circular in shape with the outer edge having a diameter from about 4 mm to about 16 mm. The outer edge may have a thickness from between about 0.5 mm to about 5 mm and a height from between about 1 mm and about 10 mm. The handle insertion apparatus 906 may also have a receiving component 910 that may be hollow and may serve as the receiving end of at least a portion of the handle. In examples, the receiving component may be circular in shape with a diameter from about 3 mm to about 15 mm and a height from about 1 mm to about 8 mm. The handle insertion apparatus 906 may also contain receiving slots 912 that may be designed to receive specific structures of the receiving handle. The receiving slots 912 may be equidistant on the circumference of the receiving component and may be hollow. The receiving slots 912 may have a width and/or height from between about 0.5 mm to about 8 mm and a depth of between about 0.5 mm to about 5 mm. The receiving slots 912 may extend horizontally below the surface to enable a locking feature that may occur when the handle is twisted. The horizontal extension may be from about 1 mm to about 8 mm.

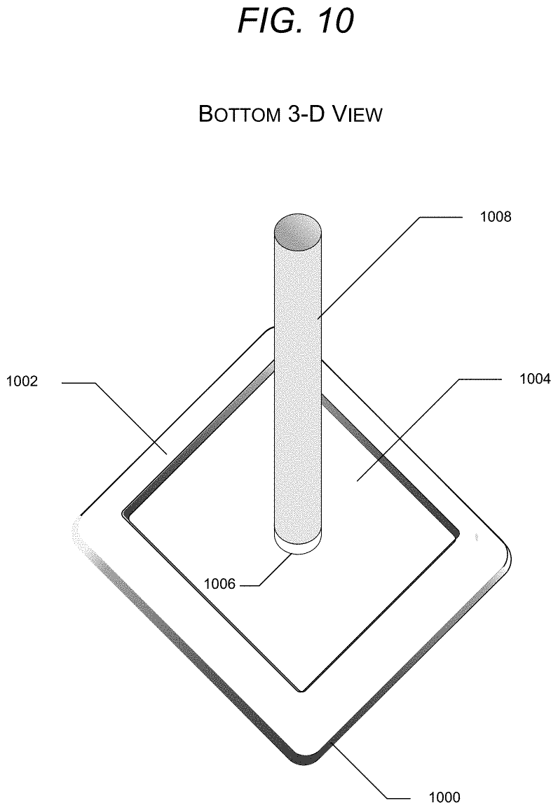

FIG. 10 illustrates a three-dimensional bottom side view of an example of a second side of a contact plate base with a handle insertion apparatus and an attached contact plate handle. In examples, the contact plate base 1000 may be generally of square or rectangular shape with rounded corners with radii ranging from about 0.5 mm to about 20 mm. However, other radii may be used. In examples, the contact plate base 1000 may have a lower portion 1002 and an upper portion 1004. In this example, the lower portion 1002 appears closer to the viewer than the upper portion 1004. In examples, the upper portion 1004 may be off-centered on the lower portion 1000 such that the width of the portion measured from the edge of the lower portion 1000 to the base of the upper portion 1004 may be from about 1 mm to about 10 mm on the widest sides (the bottom-left and bottom-right sides in FIG. 10) and from about 0.5 mm to about 5 mm on the narrowest sides (the top-left and top-right sides in FIG. 10). In examples, the upper portion 1004 may be off-centered on the lower portion 1000 such that each portion measured from the edge of the lower portion 1000 to the base of the upper portion 1004 has a different width. Alternatively, the upper portion 1004 may be centered on the lower portion 1000. The upper portion 1004 in this view is the backside of the interior space 106, 206, and 306, and may define an interior space which may have dimensions from about 30 mm to about 100 mm in length and/or width.

The upper portion 1004 may contain a handle insertion apparatus. The handle insertion apparatus 1006 may allow the insertion of a removable handle to allow for the contact plate to be held and maneuvered without directly touching the top surface of the contact plate. The handle insertion apparatus 1006 may have certain dimensions to enable specific functionality. In examples, the handle insertion apparatus 1006 may be circular in shape with a diameter from about 4 mm to about 16 mm. In examples, a contact plate handle 1008 may be cylindrical in shape and may have a diameter from about 4 mm to about 16 mm. The contact plate handle 1008 may have a length from about 30 mm to about 100 mm. In examples, the handle may have a smooth surface. In other examples, the handle may have a textured surface which may include ridges, scoring, stipples, or/or other designs to enhance grip.

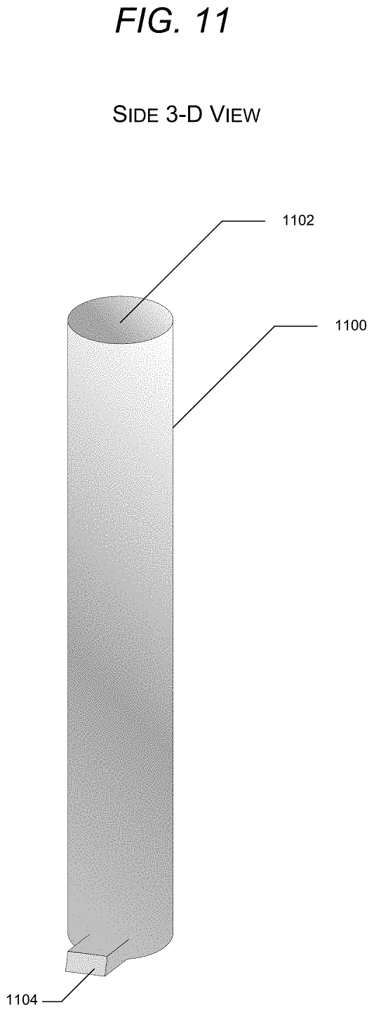

FIG. 11 illustrates a three-dimensional view of an example of a contact plate handle. The contact plate handle 1100 may have a length from about 30 mm to about 100 mm. In examples, the contact plate handle 1100 may have a flat surface located at the end of the handle which may be circular in shape with a diameter from between about 5 mm to about 15 mm. In examples, the handle may have a smooth surface. In other examples, the handle may have a textured surface which may include ridges, scoring, stipples, or/or other designs to enhance grip. In examples, the contact plate handle 1100 may have two extrusions 1104 near the opposite end of the handle from the 1102 flat surface. The two extrusions may be rectangular. In examples, the extrusions may extrude from the handle at a perpendicular angle and may be equidistant from each other. The extrusions 1104 may be from about 0.5 mm to about 5 mm in height, and from about 0.5 mm to about 9 mm in width and/or depth.

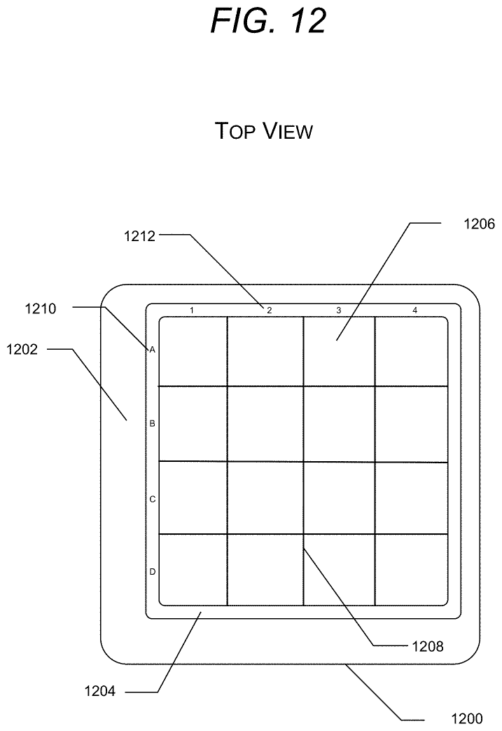

FIG. 12 illustrates a two-dimensional top view of an example of a first side of a contact plate base. In examples, the contact plate base 1200 may be generally of square or rectangular shape with rounded corners with radii ranging from 0.5 mm to about 20 mm. However, other radii may be used. In examples, the contact plate base 1200 may have a lower portion 1202 and an upper portion 1204. The lower portion 1202 may have a thickness from about 1 mm to about 10 mm. Similarly, the upper portion 1204 may have a thickness from about 1 mm to about 10 mm. In examples, the upper portion 1204 may be off-centered on the lower portion 1200 such that the width of the portion measured from the edge of the lower portion 1200 to the base of the upper portion 1204 may be from about 1 mm to about 10 mm on the widest sides (the bottom-left and bottom-right sides in FIG. 12) and from about 0.5 mm to about 5 mm on the narrowest sides (the top-left and top-right sides in FIG. 12). In examples, the upper portion 1204 may be off-centered on the lower portion 1200 such that each portion measured from the edge of the lower portion 1200 to the base of the upper portion 1204 has a different width. Alternatively, the upper portion 1204 may be centered on the lower portion 1200. In examples, the interior space 1206 may contain a grid 1208 that may provide clearly defined sections of the interior space 1206. The grid may be marked by letters 1210 and/or numbers 1212 on the edge of the upper portion 1204. The dimensions of each section in the grid may have dimensions of from about 2 mm to about 12 mm.

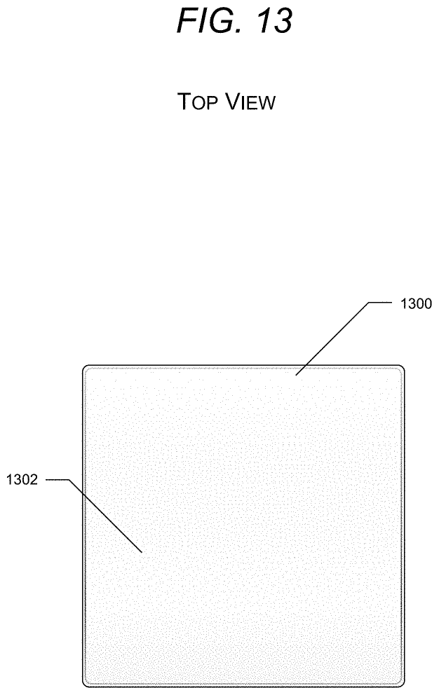

FIG. 13 illustrates a two-dimensional top view of an example of a contact plate lid. The lid 1300 may consist of four sides that extended perpendicular to a fifth side which may function as the top portion of the lid, and a sixth side that may be open to allow for the lid to fit over the edge of the upper portion. The dimensions of the lid 1300 may be from about 30 mm to about 100 mm in length and/or width. In examples, the lid 1300 may be designed as to fit over the upper portion of the contact plate such that the fifth side rests on the edge of the upper portion and/or the bottom of the four sides which contact the surface of the lower portion of the contact plate. The four sides that extend perpendicular may have a dimension from about 0.5 mm to about 20 mm. The top surface 1302 of the lid 1300 may serve as a barrier between the interior compartment of the upper portion of the contact plate and the environment. The top surface 1302 may have a thickness from about 0.1 mm to about 3 mm. In examples, the lid 1300 may be transparent and/or smooth in texture. In other examples, the lid 1300 may be opaque. Additionally or alternatively, the lid 1300 may have grooves, scorings, extrusions, stippling, and/or other textures on the surface and/or sides of the lid 1300. In examples, the top surface 1302 may have a recessed center to allow for stacking of a stand and/or base, and to prevent stacked plates from slipping off one another.

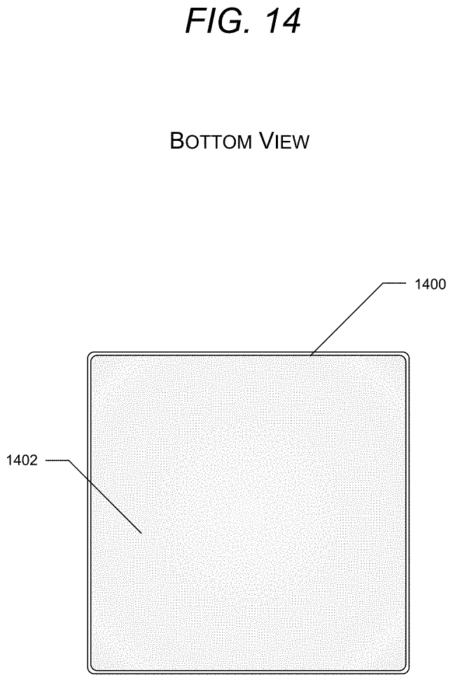

FIG. 14 illustrates a two-dimensional bottom view of an example of a contact plate lid. The lid 1400 may consist of four sides that may extended perpendicular to a fifth side which may function as the top portion of the lid, and a sixth side that may be open to allow for the lid to fit over the edge of the upper portion. The dimensions of the lid 1400 may be between about 30 mm and about 100 mm in length and/or width. In examples, the lid 1400 may be designed as to fit over the upper portion of the contact plate such that the fifth side rests on the edge of the upper portion and/or the bottom of the four sides which contact the surface of the lower portion of the contact plate. The four sides that extend perpendicular may have dimensions from about 0.5 mm to about 20 mm. The top surface 1402 of the lid 1400 may serve as a barrier between the interior compartment of the upper portion of the contact plate and the environment. The top surface 1402 may have a thickness from about 0.1 mm to about 3 mm. In examples, the lid 1400 may be transparent and/or smooth in texture. In other examples, the lid 1400 may be opaque. Additionally or alternatively, the lid 1400 may have grooves, scorings, extrusions, stippling, and/or other textures on the surface and/or sides of the lid. Additionally or alternatively, the top surface 1402 may have a recessed center to allow for stacking of a stand and/or base, and to prevent stacked plates from slipping off one another.

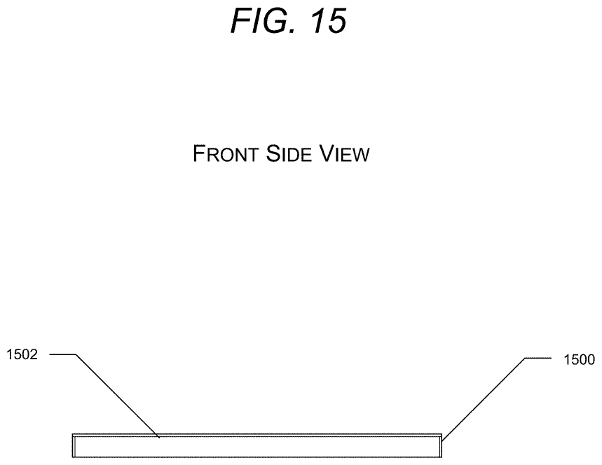

FIG. 15 illustrates a two-dimensional side view of an example of a contact plate lid. The lid 1500 may consist of four sides that extended perpendicular to a fifth side which may function as the top portion of the lid, and a sixth side that may be open to allow for the lid to fit over the edge of the upper portion. The dimensions of the lid 1500 may be from about 30 mm to about 100 mm in length and/or width. In examples, the lid 1500 may be designed as to fit over the upper portion of the contact plate such that the fifth side rests on the edge of the upper portion and/or the bottom of the four sides which contact the surface of the lower portion of the contact plate. The four sides that extend perpendicular may have dimensions from about 0.5 mm to about 20 mm. The top surface 1502 of the lid 1500 may serve as a barrier between the interior compartment of the upper portion of the contact plate and the environment. The top surface 1502 may have a thickness from about 0.1 mm to about 3 mm. In examples, the lid 1500 may be transparent and/or smooth in texture. In other examples, the lid 1500 may be opaque. Additionally or alternatively, the lid 1500 may have grooves, scorings, extrusions, stippling, and/or other textures on the surface and/or sides of the lid. In examples, the top surface 1502 may have a recessed center to allow for stacking of a stand and/or base, and to prevent stacked plates from slipping off one another.

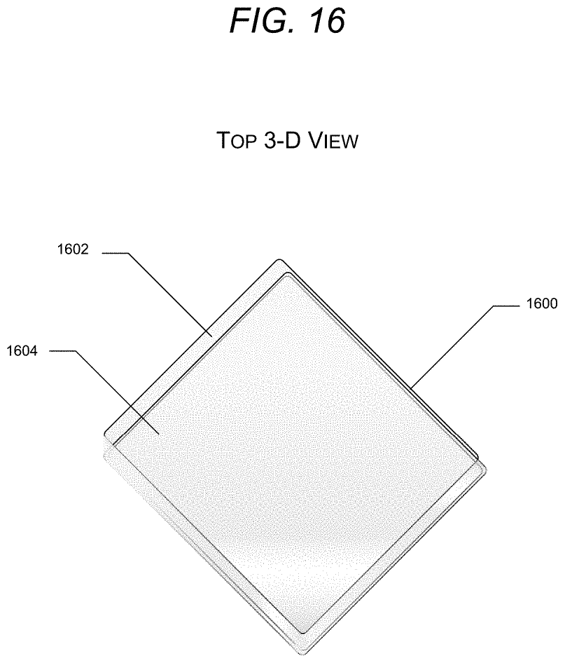

FIG. 16 illustrates a three-dimensional top view of an example of a contact plate lid. The lid 1600 may consist of four sides that may extended perpendicular to an additional fifth side which may function as the top portion of the lid, and a sixth side that may be open to allow for the lid to fit over the edge of the upper portion. The dimensions of the lid 1600 may be from about 30 mm to 100 mm in length and/or width. The lid 1600 may be designed to fit over the upper portion of the contact plate such that the fifth side of the lid 1600 may rest on the edge of the upper portion and/or the bottom four sides which contact the surface of the lower portion of the contact plate. The four sides that extend perpendicular 1602 may have dimensions from about 1 mm to about 20 mm. The top surface 1604 of the lid 1600 may serve as a barrier between the interior compartment of the upper portion of the contact plate and the environment. The top surface 1604 may have a thickness from about 0.1 mm to about 3 mm. In examples, the lid 1600 may be transparent and/or smooth in texture. In other examples, the lid 1600 may be opaque. Additionally or alternatively, the lid 1600 may have grooves, scorings, extrusions, stippling, and/or other textures on the surface and/or sides of the lid 1600.

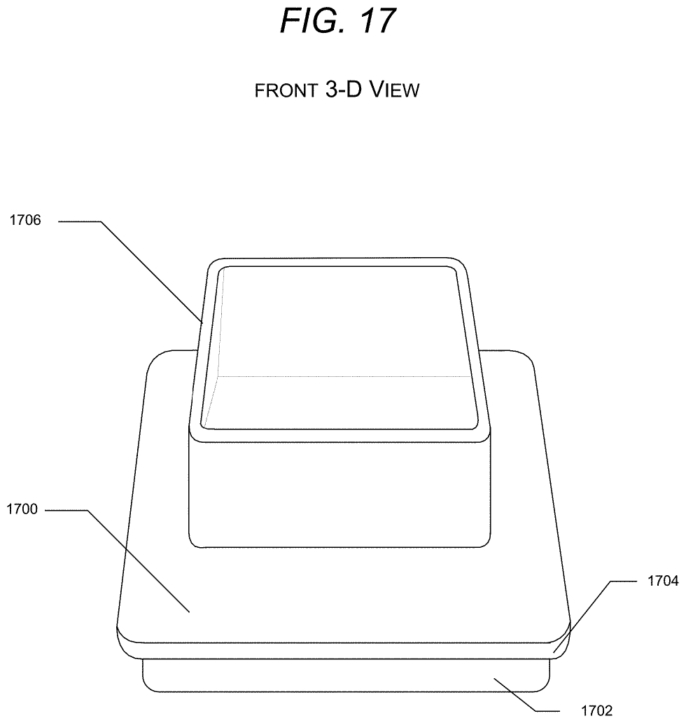

FIG. 17 illustrates a three-dimensional front view of an example of a contact plate base. The contact plate base 1700 may generally be of square or rectangular shape with rounded corners with radii ranging from about 0.5 mm to about 20 mm, however this disclosure also includes other radii other than those in this range. The contact plate base 1700 may have a lower portion 1702 and an upper portion 1704. The lower portion 1702 may have a thickness from about 1 mm to about 10 mm. Similarly, the upper portion 1704 may have a thickness from about 1 mm to about 10 mm. In examples, the upper portion 1704 may be off-centered on the lower portion 1700 such that the width of the portion measured from the edge of the lower portion 1700 to the base of the upper portion 1704 may be from about 1 mm to about 10 mm on the widest sides and from about 0.5 mm to about 5 mm on the narrowest sides. In examples, the upper portion 1704 may be off-centered on the lower portion 1700 such that each portion measured from the edge of the lower portion 1700 to the base of the upper portion 1704 has a different width. Alternatively, and as depicted in FIG. 17, the upper portion 1704 may be centered on the lower portion 1700. The upper portion 1702 may define an interior space that may be sized to receive one or more biological samples. In this example, the interior space containing a substance for collecting samples is face-down. In some examples, the contact plate base 1700 may have an attached handle 1706. In examples, the handle 1706 may be hollow. The handle 1706 may be used to handle the contact plate without contacting the contact plate base 1700, upper portion 1704, or lower portion 1702. For example, the handle 1706 may have dimensions from about 1 mm to about 5 mm wide and from about 1 mm to about 20 mm tall. In other examples, the contact plate may be rotated so that the handle 1706 rests on a surface, elevating the contact plate 1700.

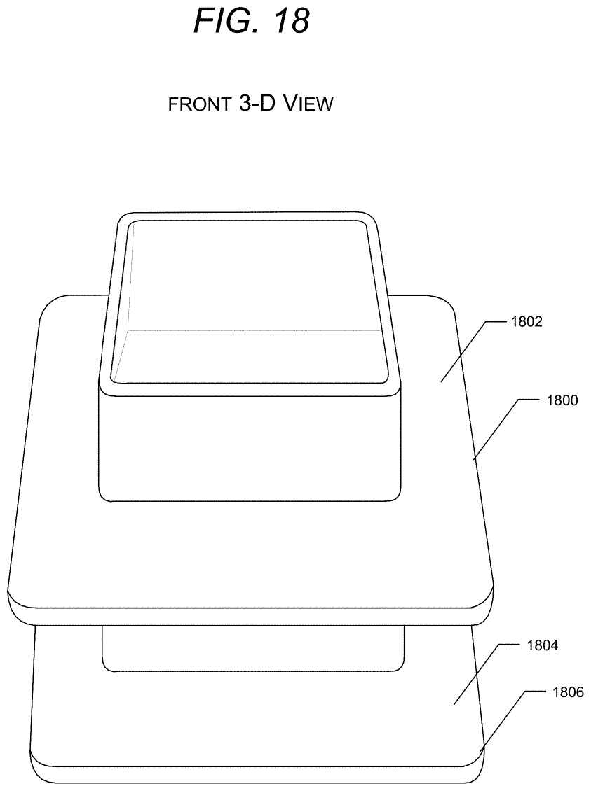

FIG. 18 illustrates a three-dimensional front view of an example first contact plate stacked upon a second contact plate. The base 1800 of the first contact plate and/or the base 1806 of the second contact plate may be the same or similar as the base 1700 depicted in FIG. 17. The base 1800 of the first contact plate may have an upper portion (not pictured) and a lower portion 1802. Similarly, the base 1806 of the second contact plate may have an upper portion (not pictured) and/or a lower portion 1804. In this example, the interior space containing a substance for collecting samples is face-down. In some examples, the first contact plate and the second contact plate may be configured such that the lid of the first contact plate (not pictured) contains a recessed center configured to stack the second contact plate.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims.

What is claimed is:

1. A contact plate comprising:
a base having a first side and a second side, the first side having a first wall and a second wall extending outward from the first side forming a right angle and defining a rectangular surface sized to receive one or more biological samples, wherein an area of the first side of the base is greater than the rectangular surface;
a rectangular lid configured to secure around the one or more walls; and
a handle removably coupled to the second side of the base.

2. The contact plate of claim 1, wherein an area of the first side of the base is greater than the rectangular surface sized to receive the one or more biological samples.

3. The contact plate of claim 1, wherein the rectangular lid contains a friction locking mechanism such that the one or more biological samples are maintained in a sterile environment.

4. The contact plate of claim 1, wherein the rectangular surface is sized to receive a substance for collecting the one or more biological samples.

5. The contact plate of claim 1, wherein the handle is configured to couple to the second side of the base by at least one of a twist-and-lock mechanism, a screw mechanism, a friction lock mechanism, or a tab mechanism.

6. The contact plate of claim 1, wherein the rectangular lid includes a recessed center configured to stack multiple plates.

7. The contact plate of claim 1, wherein the base includes one or more gridlines marked by at least one number or one letter to define the one or more biological samples.

8. The contact plate of claim 1, wherein a surface of the handle contains at least one of ridges, scoring, or stipples to enhance grip.

9. A device comprising:
a base having a first side and a second side, the first side having a first wall and a second wall extending outward from the first side forming a right angle and defining a rectangular surface sized to receive one or more biological samples; and
a rectangular lid configured to secure around the one or more walls.

10. The device of claim 9, wherein an area of the first side of the base is greater than the rectangular surface sized to receive the one or more biological samples.

11. The device of claim 9, further comprising a handle removably coupled to the second side of the base, wherein a surface of the handle contains at least one of ridges, scoring, or stipples to enhance grip.

12. The device of claim 9, wherein the rectangular lid includes a friction locking mechanism.

13. The device of claim 9, wherein the rectangular lid contains at least one of grooves, scorings, or stippling.

14. The device of claim 9, wherein the rectangular surface is sized to receive a substance for collecting the one or more biological samples.

15. The device of claim 9, further comprising a handle removably coupled to the second side of the base, wherein the handle is configured to couple to the second side of the base by at least one of a twist-and-lock mechanism, a screw mechanism, a friction lock, or a tab mechanism.

16. A contact plate comprising:
a first side having a first wall and a second wall extending outward from the first side forming a corner to define a rectangular surface sized to receive one or more biological samples for culture; and
a second side opposite the first side, the second side sized to receive a removeable handle.

17. The contact plate of claim 16, wherein an area of the first side of the contact plate is greater than the rectangular surface sized to receive the one or more biological samples.

18. The contact plate of claim 16, further comprising:
a rectangular lid configured to secure around the one or more walls; and
a handle removably coupled to the second side of the contact plate.

19. The contact plate of claim 18, wherein the handle is configured to couple to the second side of the contact plate by at least one of a twist-and-lock mechanism, a screw mechanism, a friction lock mechanism, or a tab mechanism.

20. The contact plate of claim 18, wherein the rectangular lid includes a recessed center configured to stack multiple plates.
